(19) United States
(12) Patent Application Publication
(10) Pub. No.: US 2019/0371480 A1
(43) Pub. Date: Dec. 5, 2019

(54) APPARATUS FOR GENERATING MUONS WITH INTENDED USE IN A FUSION REACTOR

(71) Applicant: NORRONT FUSION ENERGY AS, SLEMMESTAD (NO)

(72) Inventor: Leif HOLMLID, MÖLNLYCKE (SE)

(73) Assignee: NORRONT FUSION ENERGY AS, SLEMMESTAD (NO)

(21) Appl. No.: 16/349,402

(22) PCT Filed: Nov. 2, 2017
(86) PCT No.: PCT/SE2017/051086

§ 371 Date: May 13, 2019

(30) Foreign Application Priority Data
Nov. 17, 2016 (SE) 1651504-1

(51) Int. Cl. G21B 3/00

(52) U.S. Cl. CPC G21B 3/004; G21B 3/008

(57) ABSTRACT

An apparatus for generating muons, comprising: a hydrogen accumulator including an inlet; an outlet separated from the inlet by a flow path; a hydrogen transfer catalyst arranged along the flow path; and an accumulating member for receiving hydrogen in ultra-dense state from the outlet at a receiving portion of the accumulating member and accumulating the hydrogen in the ultra-dense state at an accumulation portion of the accumulating member. The accumulating member has a downward sloping surface from the receiving portion to the accumulation portion. The apparatus further includes a field source, such as a laser, arranged to provide, to the accumulation portion of the accumulating member, a field adapted to stimulate emission of negative muons from hydrogen in the ultra-dense state. The apparatus further includes a specially designed barrier and a shield to retain the super-fluid ultra-dense hydrogen from creeping away from the accumulation portion of the generator.

### FIELD OF THE INVENTION

The present invention relates to an apparatus for generating muons.

### BACKGROUND OF THE INVENTION

Fusion is one of the candidates for future large scale generation of energy without the emission problems associated with burning fossil fuel and the fuel disposal problem of traditional fission nuclear power.

Research into energy generation using fusion follows a number of parallel tracks. Most effort is currently spent on developing reactors for magnetic confinement fusion and inertial confinement fusion (ICF). Both of these tracks involve difficult problems, and it is unlikely that reliable and commercially viable fusion reactors using any of these techniques will be in operation in the near future.

An alternative process known as muon-catalyzed fusion has been known since the 1950's, and was initially seen as promising. However, it was soon realized that each muon, even if it were absolutely stable, could only catalytically react about 100 to 300 times because of a phenomenon known as “alpha-sticking” even in the most advantageous case of tritium-deuterium fusion. In addition, muons are unstable particles, which decay in about 2.2 μs.

Existing methods of producing muons, for instance using proton accelerators, are expensive and much energy is required in the muon production. Hence, to make muon-catalyzed fusion practically useful, there is a need for a cheaper and more energy-efficient way of producing muons.

### SUMMARY

It is an object of the present invention to address the above, and to provide for energy generation by muon catalyzed fusion using ultra-dense hydrogen as the working substance for producing muons.

According to a first aspect of the present invention, it is therefore provided an apparatus for generating muons, comprising: a hydrogen accumulator including: an inlet for receiving hydrogen in a gaseous state; an outlet separated from the inlet by a flow path; a hydrogen transfer catalyst arranged along the flow path between the inlet and the outlet, the hydrogen transfer catalyst having a material composition being selected to cause a transition of hydrogen from the gaseous state to an ultra-dense state; and an accumulating member for receiving hydrogen in the ultra-dense state from the outlet at a receiving portion of the accumulating member and accumulating the hydrogen in the ultra-dense state at an accumulation portion of the accumulating member, the accumulating member being configured to provide a downward sloping surface from the receiving portion to the accumulation portion; and a field source arranged to provide, to the accumulation portion of the accumulating member, a field adapted to stimulate emission of negative muons from hydrogen in the ultra-dense state.

“Hydrogen” should, in the context of the present application, be understood to include any isotope or mix of isotopes where the nucleus has a single proton. In particular, hydrogen includes protium, deuterium, tritium and any combination of these.

By hydrogen in an “ultra-dense state” should, at least in the context of the present application, be understood hydrogen in the form of a quantum material (quantum fluid) in which adjacent nuclei are within much less than one Bohr radius of each other. In other words, the nucleus-nucleus distance in the ultra-dense state is considerably less than 50 pm. In the following, hydrogen in the ultra-dense state will be referred to as H(0) (or D(0) when deuterium is specifically referred to). The terms “hydrogen in an ultra-dense state” and “ultra-dense hydrogen” are used synonymously throughout this application.

A “hydrogen transfer catalyst” is any catalyst capable of absorbing hydrogen gas molecules (H₂) and dissociating these molecules to atomic hydrogen, that is, catalyze the reaction H₂→2H. The name hydrogen transfer catalyst implies that the so-formed hydrogen atoms on the catalyst surface can rather easily attach to other molecules on the surface and thus be transferred from one molecule to another. The hydrogen transfer catalyst may further be configured to cause a transition of the hydrogen into the ultra-dense state if the hydrogen atoms are prevented from re-forming covalent bonds. The mechanisms behind the catalytic transition from the gaseous state to the ultra-dense state are quite well understood, and it has been experimentally shown that this transition can be achieved using various hydrogen transfer catalysts, including, for example, commercially available so-called styrene catalysts, as well as (purely) metallic catalysts, such as Iridium and Platinum. It should be noted that the hydrogen transfer catalyst does not necessarily have to transition the hydrogen in the gaseous state to the ultra-dense state directly upon contact with the hydrogen transfer catalyst. Instead, the hydrogen in the gaseous state may first be caused to transition to a dense state H(1), to later spontaneously transition to the ultra-dense state H(0). Also in this latter case, the hydrogen transfer catalyst has caused the hydrogen to transition from the gaseous state to the ultra-dense state.

In the dense state H(1), which is a higher-energy state than the ultra-dense state, the distance between adjacent nuclei is around 150 pm.

That ultra-dense hydrogen has actually been formed can be determined by irradiating the result of the catalytic reaction with a laser and then measuring the time of flight or velocity of the emitted particles. An example of such determination will be described in greater detail under the heading “Experimental results” further below.

The properties of ultra-dense hydrogen and methods for causing gaseous hydrogen to transition to ultra-dense hydrogen using different types of hydrogen transfer catalysts, as well as methods for detecting the presence and location of ultra-dense hydrogen, have been studied extensively by the present inventor and others. Results of these studies have, for example, been published in:

S. Badiei, P. U. Andersson, and L. Holm lid, Int. J. Hydrogen Energy 34, 487 (2009);

S. Badiei, P. U. Andersson, and L. Holmlid, Int. J. Mass. Spectrom. 282, 70 (2009);

L. Holmlid, Eur. Phys. J. A 48 (2012) 11; and

P. U. Andersson, B. Lönn, and L. Holm lid, Review of Scientific Instruments 82, 013503 (2011).

Each of these scientific articles is hereby incorporated by reference in its entirety.

It should be understood that the above-mentioned downward sloping surface from the receiving portion to the accumulation portion of the accumulating member is downwards sloping when the apparatus for muon generation according to embodiments of the present invention is set up for operation.

The present invention is based on the realization that muons can be generated cheaper and more energy efficiently than using conventional methods, by accumulating ultra-dense hydrogen and subjecting the accumulated ultra-dense hydrogen to a perturbing field (such as an electromagnetic field, including purely electric or magnetic fields). The present inventor has further realized that ultra-dense hydrogen can be accumulated by providing a downward sloping surface between one or several supply locations for ultra-dense hydrogen and an accumulation portion. Through this configuration, gravity and feed gas flow will co-operate to move the ultra-dense hydrogen from the supply locations to the accumulation portion, where ultra-dense hydrogen is thus accumulated and can be subjected to the perturbing field, such as laser radiation, to generate muons.

According to embodiments of the apparatus according to the invention, the hydrogen accumulator may further comprise: a hydrogen flow barrier surrounding the receiving portion, the accumulation portion and the downward sloping surface for reducing escape of hydrogen in the ultra-dense state from the receiving portion away from the accumulation portion.

Due to the super-fluid properties of ultra-dense hydrogen, the ultra-dense hydrogen will flow upwards, away from the accumulating portion. The provision of the above-mentioned hydrogen flow barrier can prevent, or at least substantially reduce the escape of ultra-dense hydrogen, which is due to the super-fluid properties of the ultra-dense hydrogen. Accordingly, the ratio of accumulated ultra-dense hydrogen to escaped ultra-dense hydrogen can be increased, which in turn provides for more efficient muon generation.

The barrier may advantageously have at least an outer surface facing the surrounded area that is made of a material that does not support creeping of ultra-dense hydrogen. Examples of such materials include various polymers, glass, and base metal oxides, such as aluminum oxide.

According to various embodiments, the hydrogen accumulator may further comprise a shielding member arranged between the accumulating member and the field source and shielding the outlet and the receiving portion.

The provision of a shielding member may further reduce escape of ultra-dense hydrogen, and may further protect the hydrogen transfer catalyst, at least in embodiments where the hydrogen transfer catalyst would otherwise be exposed to laser radiation.

Furthermore, the shielding member may advantageously be arranged to expose the accumulation portion to the field provided by the field source. In embodiments where the above-mentioned perturbing field is provided in the form of laser radiation, the shielding member may be open over the accumulation portion to allow the laser radiation to hit the accumulated ultra-dense hydrogen in the accumulation portion.

As described above for the barrier, at least a surface of the shielding member facing the accumulating member may be made of a material selected from the group consisting of a polymer, and a base metal oxide, to reduce creeping of ultra-dense hydrogen.

According to various embodiments, furthermore, the hydrogen accumulator may further comprise a metallic absorbing member for absorbing hydrogen in the ultra-dense state, arranged in the accumulation portion of the hydrogen accumulating member.

Hereby, the super-fluid ultra-dense hydrogen can be retained in the accumulation portion, which provides for a more efficient generation of muons.

Advantageously, the metallic absorbing member may be made of at least one material selected from the group consisting of a metal in a liquid state at an operating temperature for the apparatus, and a catalytically active metal in a solid state at the operating temperature for the apparatus.

Examples of suitable materials for the metallic absorbing member include liquid or easily melted metals like Ga or K, and solid catalytically active metals like Pt or Ni etc.

According to various embodiments, the apparatus of the invention may further comprise a heating arrangement for increasing a temperature of the accumulating member comprised in the hydrogen accumulator.

By increasing the temperature of the accumulating member, the ultra-dense hydrogen can be transitioned from a super fluid to a normal fluid, which may reduce the amount of ultra-dense hydrogen escaping from the accumulating member through super-fluid creeping.

According to embodiments, moreover, the outlet may be arranged at the receiving portion of the accumulating member. Further, the outlet may an integral portion of the accumulating member.

The hydrogen transfer catalyst may advantageously be porous, so that the hydrogen in the gaseous state can flow through the pores. This will provide for a large contact area between the hydrogen gas and the hydrogen transfer catalyst. At the same time, however, flow through the pores only will limit the attainable flow rate and thus possibly the rate of production of ultra-dense hydrogen.

The present inventor has found that flow through the pores of the hydrogen transfer catalyst is not necessary for causing the transition of the hydrogen from the gaseous state to the ultra-dense state, but that the hydrogen transfer catalyst is capable of causing this transition at a larger distance and more efficiently than was previously believed. Accordingly, the hydrogen gas can be allowed to flow over a surface of the hydrogen transfer catalyst rather than be forced to flow through the hydrogen transfer catalyst.

According to various aspects, furthermore, the field source may be a laser arranged to irradiate hydrogen in the ultra-dense state accumulated in the accumulation portion of the accumulating member; the accumulating member comprised in the hydrogen accumulator may have an lower face and a concave upper face with a plurality of holes extending from the lower face to the concave upper face, each hole in the plurality of holes defining a flow path having an inlet on the lower face and an outlet on the upper face, a lowest portion of the upper concave face being the accumulation portion; and each of the holes may accommodate a hydrogen transfer catalyst having the material composition being selected to cause transition of hydrogen from the gaseous state to the ultra-dense state. Further, a barrier may surround the upper face; and a shielding member having a shielding member opening is arranged to, together with the barrier and the upper face form a partly enclosed space for preventing escape of hydrogen in the ultra-dense state, while allowing the laser to irradiate the accumulation portion through the shielding member opening.

Moreover, the apparatus for generating muons, according to various embodiments of the present invention may advantageously be included in a fusion reactor, further comprising a hydrogen vessel, wherein the apparatus is arranged to generate negative muons impinging on the hydrogen vessel, to catalyze fusion in the hydrogen vessel.

In summary, the present invention relates to an apparatus for generating muons, comprising: a hydrogen accumulator including an inlet; an outlet separated from the inlet by a flow path; a hydrogen transfer catalyst arranged along the flow path between the inlet and the outlet; and an accumulating member for receiving hydrogen in ultra-dense state from the outlet at a receiving portion of the accumulating member and accumulating the hydrogen in the ultra-dense state at an accumulation portion of the accumulating member. The accumulating member has a downward sloping surface from the receiving portion to the accumulation portion. It has also several advanced features for handling the superfluid ultra-dense material like a barrier and a shield. The apparatus further includes a field source, such as a laser, arranged to provide, to the accumulation portion of the accumulating member, a field adapted to stimulate emission of negative muons from hydrogen in the ultra-dense state.

### BRIEF DESCRIPTION OF THE DRAWINGS

These and other aspects of the present invention will now be described in more detail, with reference to the appended drawings showing example embodiments of the invention, wherein:

FIG. 1 is a schematic block diagram of a fusion reactor including a muon generator according to embodiments of the present invention;

FIG. 2 is an exploded perspective view of an example embodiment of the apparatus for generating muons, according to the present invention;

FIG. 3 is a schematic illustration of an exemplary measurement setup for detecting generation of negative muons;

FIG. 4 is a diagram of measurements obtained using a similar setup as that shown in FIG. 3.

### DETAILED DESCRIPTION OF EXAMPLE EMBODIMENTS

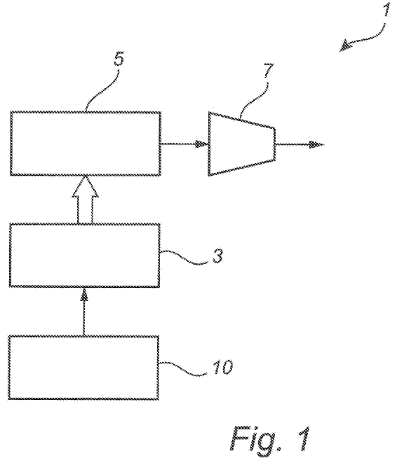

FIG. 1 is a schematic block diagram functionally illustrating a fusion reactor for muon catalyzed fusion using muon generator according to embodiments of the present invention.

The fusion reactor 1 comprises a muon generator 10, a vessel 3 containing hydrogen gas (which may, for example, be a suitable mix of protium, deuterium, and tritium), a vaporizer 5, and an electrical generator 7.

As is schematically shown in FIG. 1, muons generated by the muon generator 10 are used for catalyzing fusion according to, per se, known fusion reactions in the vessel 3. Heat resulting from the fusion reactions in the vessel 3 is used for vaporizing a process fluid, such as water, in the vaporizer. The resulting vapor-phase process fluid, such as steam, is used to drive the electrical generator 7, resulting in output of electrical energy. If only heat is needed, the electrical generator is not needed.

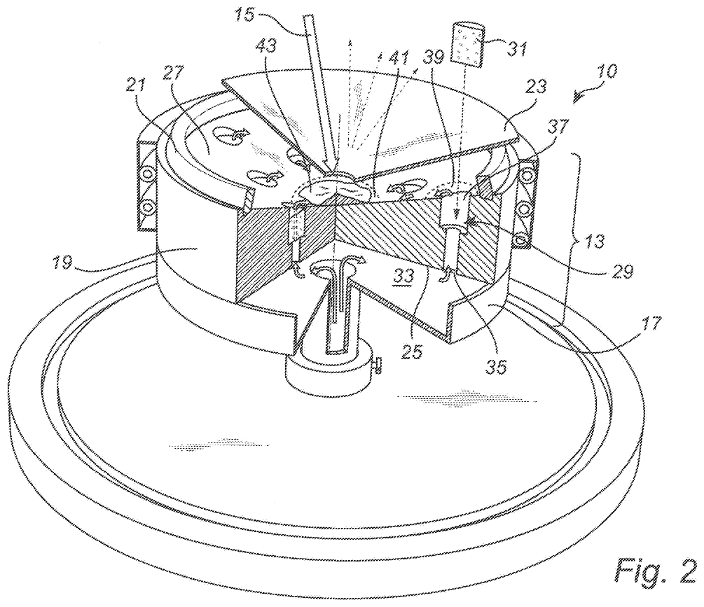

FIG. 2 is a schematic illustration of an example embodiment of the apparatus for generating muons according to the present invention. In the following, the apparatus will generally be referred to as “muon generator”.

With reference to FIG. 2, the muon generator 10 comprises a hydrogen accumulator 13, and a field source, here in the form of a laser (not shown in FIG. 2, but represented by a block arrow illustrating a laser beam 15). As is schematically indicated in FIG. 2, the hydrogen accumulator 13 comprises a hydrogen gas intake member 17, an accumulating member 19, a barrier 21, here in the form of a gasket and a shielding member 23.

As is shown in FIG. 2, the accumulating member 19 has a lower face 25 and a concave upper face 27. In the particular example shown in FIG. 2, the concave upper face 27 is generally conical, with a rounded apex. A plurality of holes 29 (only one of the holes is indicated by a reference numeral to avoid cluttering the drawings) extend through the accumulating member 19 from the lower face 25 to the upper face 27, and a corresponding plurality of hydrogen transfer catalyst plugs 31 (only one of the catalyst plugs is indicated by a reference numeral to avoid cluttering the drawings) are accommodated by the holes 29.

In the example embodiment of FIG. 2, the lower face 25 of the accumulating member 19 forms the lid of an inlet chamber 33 for hydrogen gas, further defined by the hydrogen gas intake member 17. Each of the holes 29 formed through the accumulating member 19 has an inlet 35 for receiving hydrogen gas from the inlet chamber 23, and an outlet 37 for providing ultra-dense hydrogen to receiving portions 39 on the upper face 27 of the accumulating member 19.

Due to the conical shape of the upper face 27 of the accumulating member 19, the ultra-dense hydrogen provided to the receiving portions 39 tends to mainly flow towards the accumulation portion 41 at the bottom of the “bowl” formed by the upper face 27 of the accumulating member 19.

Due to the super-fluid behavior of ultra-dense hydrogen (below a transition temperature between the super-fluid state and the normal-fluid state of ultra-dense hydrogen), some of the ultra-dense hydrogen provided to the receiving portions 39 may flow upwards, away from the accumulation portion 41. This flow is hindered by the barrier 21, and also by the shielding member 23.

To even further increase the amount of ultra-dense hydrogen in the accumulation portion 41, the hydrogen accumulating member 13 additionally comprises an ultra-dense hydrogen retaining member 43 arranged in the accumulation portion 41. The ultra-dense hydrogen retaining member 43 may, as was explained further above in the Summary section, be made of a liquid metal or a solid metal capable of absorbing ultra-dense hydrogen.

It should be noted that many different shapes of the concave upper face 27 are possible. For instance, the concave upper face 27 need not be rotationally symmetrical, as long as there is a sloping surface portion from the receiving portion(s) 29 towards the accumulation portion 41.

The ultra-dense hydrogen accumulated in the accumulation portion 41 is subjected to a perturbing field using the field source (indicated by the laser beam 15). In the example embodiment of FIG. 2, the field source is a laser and the perturbing field is thus provided in the form of laser radiation.

The person skilled in the art realizes that the present invention by no means is limited to the preferred embodiments described above. On the contrary, many modifications and variations are possible within the scope of the appended claims.

In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

Theoretical Discussion

Ultra-Dense Hydrogen and Muon Generation

Ultra-dense hydrogen H(0) is a quantum material at room temperature. It is described in several scientific publications, with detailed studies of the structure of D(0) and also of its protium analog p(0). It is shown to be both superfluid and superconductive at room temperature. Due to the normally measured very short p-p and D-D distances of 2.3 pm and below, the density of H(0) is very high.

While ordinary (orbital angular momentum l) based Rydberg matter has l>0 for its binding electrons, this ultra-dense matter has l=0 and s>0 (1, 2, 3, 4 . . . ) which is the spin quantum number for the binding electrons. Thus, the electrons which give the ultra-dense matter structure have no orbital motion, but only a spin motion. This electron spin motion may be interpreted as a motion of the charge with orbit radius r_{q}=ℏ/2mₑc=0.192 pm and with the velocity of light c (‘Zitterbewegung’). This spin motion is centered on the H atoms and may give a planar structure for the H—H pairs as in the case of the planar clusters for ordinary Rydberg matter. This means that the interatomic distance in ordinary Rydberg matter which is d=2.9 l² a₀ is replaced with d=2.9 s² r_{q} for the ultra-dense matter, as verified by direct measurements. Here, 2.9 is a constant determined numerically for ordinary Rydberg matter and confirmed experimentally by radio frequency spectroscopy. It is also confirmed for ultra-dense hydrogen by visible emission spectroscopy. The Bohr radius is indicated as a₀. The spin-circling electronic charges provide the necessary shielding of the nuclei which keeps the material strongly bound, similar to ordinary Rydberg matter but with much larger binding energies.

The mechanism of formation of ultra-dense matter starts with the formation of higher normal Rydberg matter levels (l=1-3), which are formed spontaneously at the catalyst surface. It implies that the ultra-dense hydrogen is formed from ordinary Rydberg matter levels l=1-3 falling down to the lower energy ultra-dense states. The nuclear processes taking place in H(0) spontaneously and under laser impact or other field induction processes are still not completely known. However, several different steps have been studied separately. For example, the laser induces the transition from s=2 to s=1 in H(0). The total process giving the negative muons required for the muon-catalyzed fusion starts with the ultra-dense hydrogen particles H_{N}(0) and is proposed to be:

H_{N}(0)(s=1)→→(pe)(pe)→nn̅→K^{±}+K⁰+π^{±}→decay→μ⁻,

where n̅ is an anti-neutron, formed from the “quasi-neutrons” (pe) (proton+electron). The mesons formed are all types of kaons and pions, and it is likely that three kaons are formed from each H_{N}(0) particle since this conserves the number of quarks. Over all, the number of quarks is largely unchanged in the meson formation step, but further pair production of pions is also possible which does not conserve the number of quarks. The process shown is highly exoergic and gives much more than 100 MeV to the particles ejected from each pair of protons. This should be compared to ordinary D+D fusion, which has an output per pair of deuterons of 4-14 MeV depending on the conditions like temperature.

Catalytic Conversion

The catalytic process for converting hydrogen gas to ultra-dense hydrogen may employ commercial so called styrene catalysts, i.e. a type of solid catalyst used in the chemical industry for producing styrene (for plastic production) from ethylene benzene. This type of catalyst is made from porous Fe—O material with several different additives, especially potassium (K) as so called promoter. The function of this catalyst has been studied in detail by several different groups.

The catalyst is designed to split off hydrogen atoms from ethyl benzene so that a carbon-carbon double bond is formed, and then to combine the hydrogen atoms so released to hydrogen molecules which easily desorb thermally from the catalyst surface. This reaction is reversible: if hydrogen molecules are added to the catalyst they are dissociated to hydrogen atoms which are adsorbed on the surface. This is a general process in hydrogen transfer catalysts. We utilize this mechanism to produce ultra-dense hydrogen, which requires that covalent bonds in hydrogen molecules are not allowed to form after the adsorption of hydrogen in the catalyst.

The potassium promoter in the catalyst provides for a more efficient formation of ultra-dense hydrogen. Potassium (and for example other alkali metals) easily forms so called circular Rydberg atoms K*. In such atoms, the valence electron is in a nearly circular orbit around the ion core, in an orbit very similar to a Bohr orbit. At a few hundred ° C. not only Rydberg states are formed at the surface, but also small clusters of Rydberg states K_{N}*, in a form called Rydberg Matter (RM).

The clusters K_{N}* transfer part of their excitation energy to the hydrogen atoms at the catalyst surface. This process takes place during thermal collisions in the surface phase. This gives formation of clusters H_{N}* (where H indicates proton, deuteron, or triton) in the ordinary process also giving the K_{N}* formation, namely cluster assembly during the desorption process. If the hydrogen atoms could form covalent bonds, molecules H₂ would instead leave the catalyst surface and no ultra-dense material could be formed. In the RM material, the electrons are not in so-called s orbitals since they always have an orbital angular momentum greater than zero. This implies that covalent bonds cannot be formed since the electrons on the atoms must be in s orbitals to form the normal covalent sigma (σ) bonds in H₂. The lowest energy level for hydrogen in the form of RM is metallic (dense) hydrogen called H(1), with a bond length of 150 picometer (pm). The hydrogen material falls down to this level by emission of mainly infrared radiation. Dense hydrogen is then spontaneously converted to ultra-dense hydrogen called H(0) with a bond distance of 0.5-5 pm depending on the spin level. This material is a quantum material (quantum fluid) which may involve both electron pairs (Cooper pairs) and nuclear pairs (proton, deuteron or triton pairs, or mixed pairs). These materials are both superfluid and superconductive at room temperature, as confirmed in several experiments.

Experimental Results

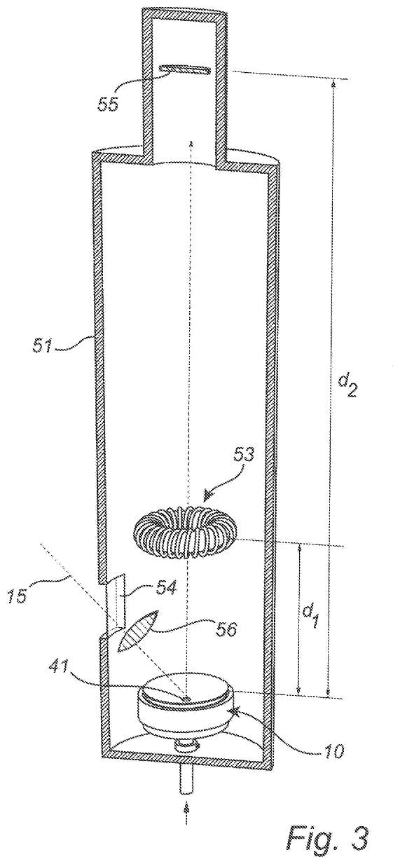

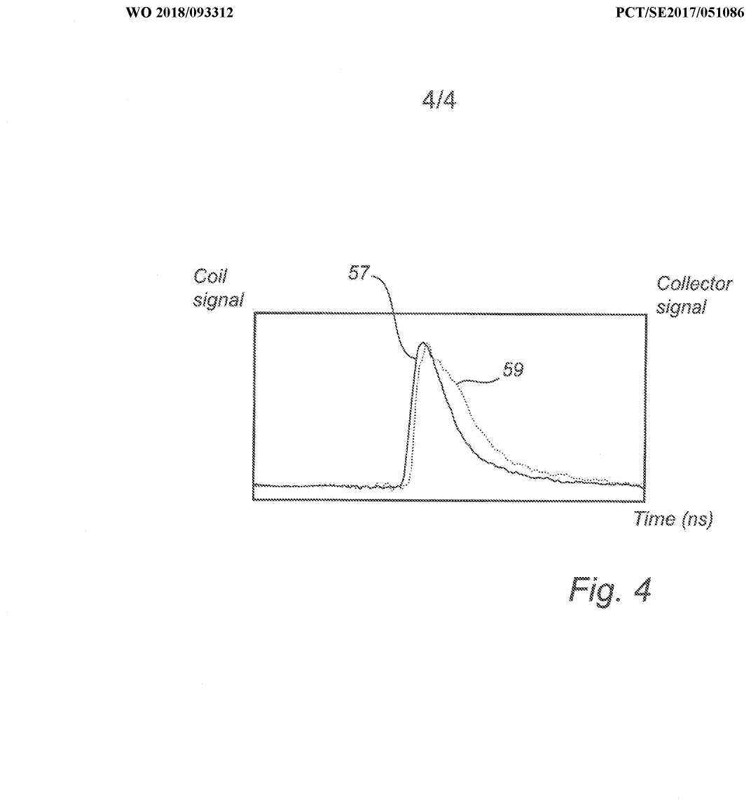

Results are here given which characterize a muon generator like the apparatus 10 schematically shown in FIG. 2, with reference to FIG. 3 illustrating an experimental setup, and FIG. 4 showing results of measurements carried out using a similar experimental setup.

Referring to FIG. 3, the experimental setup comprises a vacuum chamber 51, the muon generator 10 described above with reference to FIG. 2, a toroidal coil 53, and a collector 55. There is a first distance d₁ between the accumulation portion 41 and the coil, and a second distance d₂ between the accumulation portion 41 and the collector 55. As is schematically indicated in FIG. 3, the vacuum chamber 51 has a window 54 for allowing passage of a laser beam 15. A lens 56 is provided inside the vacuum chamber 51 for focusing the laser beam 15 at the accumulation portion 41 of the muon generator 10.

The D₂ gas pressure in the vacuum chamber 51 is around 1 mbar with constant pumping.

In the present experimental setup, the field source comprised in the muon generator is a pulsed laser with pulse length in the few nanosecond range. Both visible and infrared laser light give similar behavior. The pulse energy used for the typical experiments is of the order of 200-400 mJ. With a pulse repetition rate of 10 Hz typical, this means only 2-4 W of laser power outside the vacuum chamber. The effective laser power at the muon generator is somewhat lower, due to losses by reflection in beam steering mirrors, in the glass window 54 in the vacuum chamber wall and in the focusing lens 56.

The laser beam is normally focused on the accumulation portion 41 of the muon generator using a lens 56 of 40-50 mm focal length, but the focusing is not critical.

Experiments have been performed with a current transformer which directly measures the current from the laser-induced nuclear processes using the toroidal coil 53. A wire is there wound around a ferrite toroidal core, with around 20 turns of wire on a toroid of a few cm diameter. The pulse of charges from the laser-induced nuclear processes on the generator is observed as an induced current in the coil. This is a standard method of measuring the pulse current for example in electron accelerators with the particles moving at relativistic velocities. In the present experiments, the beam passing through the coil is additionally observed the foil collector 55. This means that absolute calibration is possible.

For a somewhat simplified measurement case using similar equipment as that schematically illustrated in FIG. 3, FIG. 4 shows a first signal 57 obtained from a coil, such as the coil 53 in FIG. 3, and a second signal 59 obtained from a collector, such as the collector in FIG. 3. The known distance between the coil 53 and the collector 55 of about 1 m, and the measured delay of about 3 ns indicates charged particles traveling close to the speed of light. Since the coil only gives a signal due to charged particles, photons are excluded as the particles giving the signals.

The curve shape of the signal in FIG. 4 agrees well with that calculated for a meson in a decay chain, with a time constant for the decay of 12 ns. This is the characteristic decay time for charged kaons K^{±}. In several published studies also characteristic decay times of 26 and 52 ns have been measured, indicating decay of charged pions π^{±} and neutral long-lived kaons K_{L}⁰. It is well-known that all these particles decay to the much more long-lived muons μ^{±}, which are the particles mainly observed in the coil and at the collector in FIG. 4. Relevant publications include:

L. Holmlid, Int. J. Modern Phys. E 24 (2015) 1550026.

L. Holmlid, Int. J. Modern Phys. E 24 (2015) 1550080.

L. Holmlid, Int. J. Modern Phys. E 25 (2016) 1650085.

To ascertain that muons are formed, also several published studies have directly measured the decay of the muons and their interaction with matter including electron-positron pair production. The direct decay time of free muons at 2.2 μs has also been measured, and slightly shorter decay times due to muon interaction with other particles like nuclei. Relevant publications include:

L. Holmlid and S. Olafsson, Int. J. Hydr. Energy 40 (2015) 10559-10567

L. Holmlid and S. Olafsson, Rev. Sci. Instrum. 86, 083306 (2015).

L. Holmlid and S. Olafsson, Int. J. Hydrogen Energy 41 (2016) 1080-1088.

S. Olafsson and L. Holmlid, Bull. Am. Phys. Soc. 2016/4/16. BAPS.2016.APR.E9.9.

1. An apparatus for generating muons, comprising:
an ultra-dense hydrogen accumulator including:
an inlet for receiving hydrogen in a gaseous state;
an outlet separated from said inlet by a flow path;
a hydrogen transfer catalyst arranged along the flow path between said inlet and said outlet, said hydrogen transfer catalyst having a material composition being selected to cause a transition of hydrogen from the gaseous state to an ultra-dense state; and
an accumulating member for receiving hydrogen in the ultra-dense state from said outlet at a receiving portion of the accumulating member and accumulating said hydrogen in the ultra-dense state at an accumulation portion of the accumulating member, the accumulating member being configured to provide a downward sloping surface from said receiving portion to said accumulation portion; and
a field source arranged to provide, to the accumulation portion of said accumulating member, a field adapted to stimulate or induce emission of negative muons from hydrogen in the ultra-dense state.

2. The apparatus according to claim 1, wherein said hydrogen accumulator further comprises:
a barrier surrounding said receiving portion, said accumulation portion and said downward sloping surface for reducing escape of hydrogen in the ultra-dense state.

3. The apparatus according to claim 2, wherein said barrier has at least an outer surface made of a material selected from the group consisting of a polymer, and a base metal oxide.

4. The apparatus according to claim 1, wherein said hydrogen accumulator further comprises:
a shielding member arranged between said accumulating member and said field source and shielding said outlet and said receiving portion.

5. The apparatus according to claim 4, wherein said shielding member is arranged to expose said accumulation portion to the field provided by said field source.

6. The apparatus according to claim 4, wherein at least a surface of said shielding member facing said accumulating member is made of a material selected from the group consisting of a polymer, a base metal oxide, and a metal.

7. The apparatus according to claim 1, wherein said hydrogen accumulator further comprises:
a metallic absorbing member for absorbing hydrogen in the ultra-dense state, arranged in said accumulation portion of the hydrogen accumulating member.

8. The apparatus according to claim 7, wherein said metallic absorbing member is made of at least one material selected from the group consisting of a metal in a liquid state at an operating temperature for said apparatus and a catalytically active metal in a solid state at the operating temperature for said apparatus.

9. The apparatus according to claim 1, further comprising a heating arrangement for increasing a temperature of the accumulating member comprised in said hydrogen accumulator.

10. The apparatus according to claim 1, wherein said outlet is arranged at the receiving portion of said accumulating member.

11. The apparatus according to claim 10, wherein said outlet is an integral portion of said accumulating member.

12. The apparatus according to claim 1, wherein said field source is a laser arranged to irradiate the accumulation portion of said accumulating member of the hydrogen accumulator.

13. The apparatus according to claim 1,
wherein said field source is a laser arranged to irradiate hydrogen in the ultra-dense state accumulated in the accumulation portion of said accumulating member;
wherein the accumulating member comprised in said hydrogen accumulator has an lower face and a concave upper face with a plurality of holes extending from said lower face to said concave upper face, each hole in said plurality of holes defining a flow path having an inlet on said lower face and an outlet on said upper face, a lowest portion of said upper concave face being said accumulation portion;
wherein each of said holes accommodates a hydrogen transfer catalyst having said material composition being selected to cause transition of hydrogen from the gaseous state to the ultra-dense state;
wherein a barrier surrounds said upper face; and
wherein a shielding member having a shielding member opening is arranged to, together with said barrier and said upper face form a partly enclosed space for preventing escape of hydrogen in the ultra-dense state, while allowing said laser to irradiate said accumulation portion through said shielding member opening.

14. A fusion reactor comprising:
a hydrogen vessel; and
an apparatus according to claim 1, arranged to generate negative muons impinging on said hydrogen vessel, to catalyze fusion in said hydrogen vessel.
